(19) United States
(12) Patent Application Publication
(10) Pub. No.: US 2013/0329862 A1
(43) Pub. Date: Dec. 12, 2013

(54) BACKSCATTER REDUCTION DEVICE (BSR)

(71) Applicant: Blake SAMPSON, Rochester, NY (US)

(72) Inventor: Blake SAMPSON, Rochester, NY (US)

(73) Assignee: University of Rochester, Rochester, NY (US)

(21) Appl. No.: 13/494,759

(22) Filed: Jun. 12, 2012

(51) Int. Cl. G21K 1/00

(52) U.S. Cl. 378/154

(57) ABSTRACT

A backscatter reduction device has a lead or lead-equivalent density sheet or foil inside a cover, such as a rigid or semirigid plastic cover. The device is placed behind an x-ray imaging plate without backscatter protective measures, thereby significantly reducing and/or eliminating backscatter radiation from backscattering objects such as the patient's bed frame. The backscatter reduction device can be combined with a radiographic grid.

### FIELD OF THE INVENTION

The present invention is directed to backscatter reduction and more particularly to backscatter reduction for portable x-ray systems.

### DESCRIPTION OF RELATED ART

In x-ray exams, as shown in FIG. 1, x-ray beams X emitted by an x-ray source 1 move through the patient's body P to the imaging plate 3 to create the image. However, in portable examinations, backscattered x-ray beams B can and often do rebound off the patient's metal bed 5 and back towards the imaging plate 3, thus degrading image quality and increasing the patient's radiation dose. That problem has occurred with at least one new imaging plate used at the University of Rochester Strong Memorial Hospital, creating images in which the internal electronic components of the imaging plate as well as the body part examined are visualized.

Previously, lead foil backing was used when x-rays were taken on film; however, in the two newest imaging technologies (CR and DR plates, which are digital), most manufacturers have neglected to include it for unknown reasons. The reason could be lack of space within the plates and/or the relative newness of the technology. There is currently no way to retrofit such a plate for backscatter reduction. There are also no other existing technologies that take the form of an external device for use with multiple imaging plates.

### SUMMARY OF THE INVENTION

There thus exists a need in the art to provide backscatter protection for imaging plates that do not have such protection built in. It is therefore an object to provide such protection in an aftermarket device. It is another object of the invention to supplement a wide range of imaging plates from different manufacturers.

To achieve the above and other objects, the present invention is directed to a backscatter reduction device having a lead or lead-equivalent density sheet or foil inside a cover, such as a rigid or semirigid plastic cover. The device is placed behind an x-ray imaging plate without backscatter protective measures, thereby significantly reducing and/or eliminating backscatter radiation.

Construction can include some variation of lead, rubberized lead, foil lead or lead equivalent, attached to, encased within or suspended inside of some sort of rigid or semirigid material that is safe for skin contact and sturdy enough to support heavy loads.

### BRIEF DESCRIPTION OF THE DRAWINGS

Preferred embodiments of the present invention will be set forth in detail with reference to the drawings, in which:

FIG. 1 is a schematic diagram showing the origin of backscatter in known portable x-ray procedures;

FIG. 2 is a schematic diagram showing the use of the backscatter reduction device according to the first preferred embodiment in reducing backscatter;

FIGS. 3-5 are diagrams showing three variations of the backscatter reduction device;

FIGS. 6A and 6B are perspective views of a second preferred embodiment; and

FIGS. 6C-6G are back, front, side, top, and bottom views, respectively, of the second preferred embodiment.

### DETAILED DESCRIPTION OF THE PREFERRED EMBODIMENTS

Preferred embodiments of the present invention and variations thereof will be set forth in detail with reference to the drawings, in which like reference numerals refer to like elements throughout.

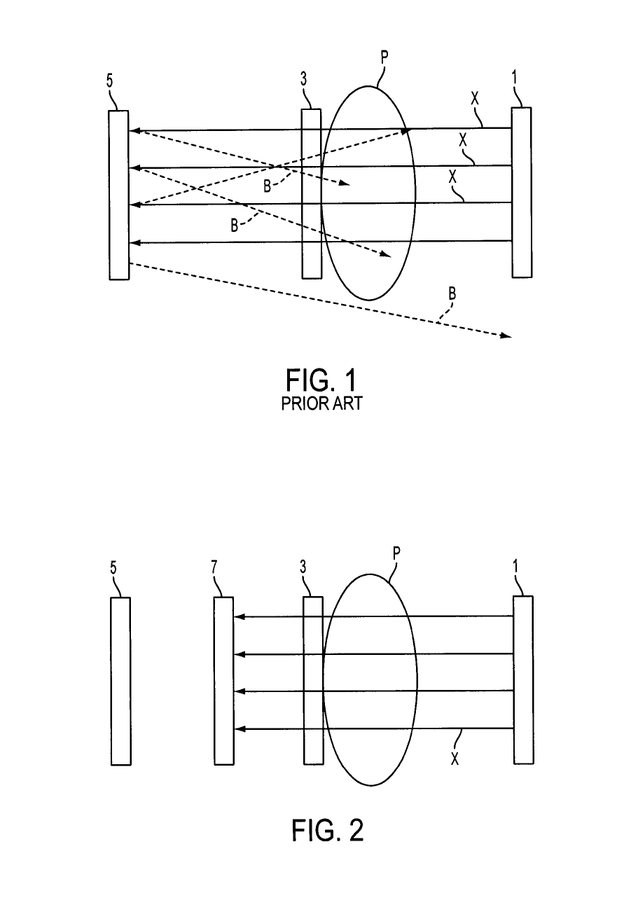

FIG. 2 shows a backscatter reduction device 7 according to the first preferred embodiment disposed between the imaging plate 3 and the patient's metal bed frame 5 during x-ray imaging. Since the x-rays X are attenuated before reaching the bed frame 5, the effect of backscatter on the image is reduced to acceptable levels or eliminated.

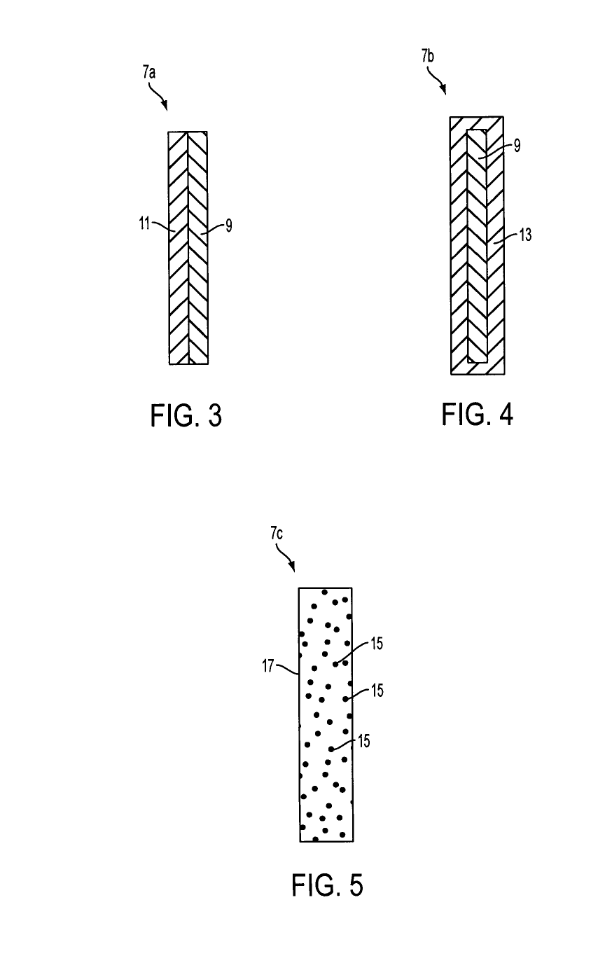

FIGS. 3-5 show three variations of the backscatter reduction device 7 according to three variations of the first preferred embodiment. The backscatter reduction device 7a of FIG. 3 includes a sheet 9 of lead, rubberized lead, foil lead or lead equivalent on a backing 11 of rigid or semirigid plastic. The backscatter reduction device 7b of FIG. 4 includes a sheet 9 of lead, rubberized lead, foil lead or lead equivalent in an envelope 13 of rigid or semirigid plastic. The backscatter reduction device 7c of FIG. 5 includes particles 15 of lead, rubberized lead, foil lead or lead equivalent suspended in a matrix 17 of rigid or semirigid plastic. Any other suitable configuration of a material for attenuating the x-rays and a material for providing physical support can be used.

The backscatter reduction device 7 (7a, 7b, 7c) can be sized to be usable with any suitable imaging plate and should preferably be sized to be usable with more than one commercially available imaging plate. The rigid or semirigid plastic supports the x-ray-attenuating material to form a free-standing unit, as opposed to the lead foil of the prior art, which had to be built into the imaging plate.

A second preferred embodiment will now be described. The second preferred embodiment combines two technologies into a comprehensive mobile imaging solution. The first is an existing technology, already commonly used in imaging, called a radiographic grid. Grids are used in many different settings, including mobile imaging or imaging utilizing an autonomous imaging plate (CR or DR cassette in a radiographic room). The grid, which is placed between the patient and the imaging plate, minimizes any scatter radiation emanating from the patient from reaching the imaging plate. Some previous forms of grids have included a flat board sized to the imaging plate, a snap-on grid, and a sleeve.

The second preferred embodiment builds upon the concept of the sleeve type of grid. The second preferred embodiment adds a backscatter reduction device, such as that of any suitable variation of the first preferred embodiment, behind the plate and the grid. The grid and backscatter reduction device can form one solid unit in which the imaging plate sits. Because the joined grid and back scatter device can rely on each other and the imaging plate for overall strength, each element can be thinner. The resulting piece of equipment envelops the imaging plate and provides a complete solution for minimizing scatter radiation in any form from reaching autonomous imaging plates, mobile or otherwise.

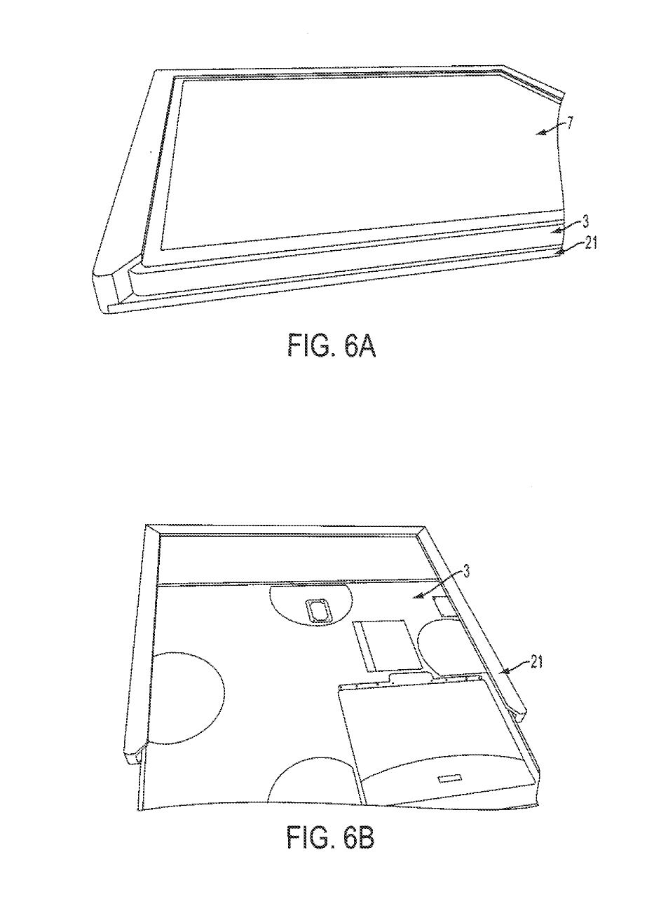

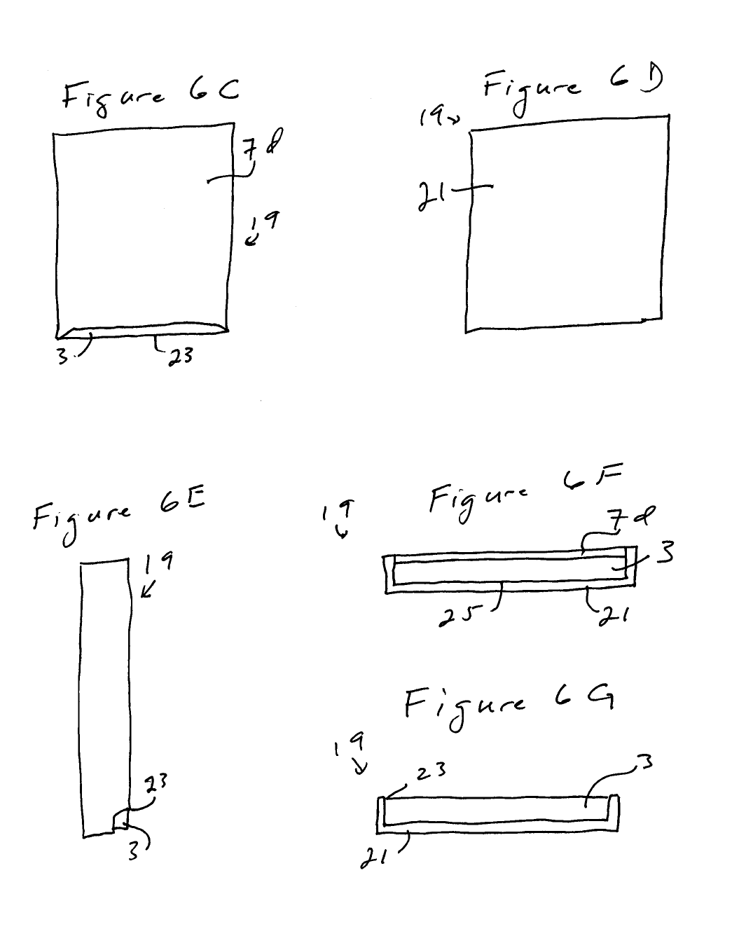

FIGS. 6A-6G show the second preferred embodiment. An assembly 19 includes an image plate 3 sandwiched between a backscatter reduction device 7d, which can be configured like any of the backscatter reduction devices of the first preferred embodiment, and a sleeve-like x-ray grid 21. The backscatter reduction device 7d has a cutout 23 to access the imaging plate 3, which slides out from the bottom. The imaging plate can be pushed out through a cutout or opening 25 in the top of the assembly.

While two preferred embodiments and variations thereof have been set forth above, those skilled in the art who have reviewed the present disclosure will readily appreciate that other embodiments can be realized within the scope of the invention. For example, any materials having suitable properties can be used. Also, the invention can be used for portable or non-portable x-ray imaging. Therefore, the present invention should be construed as limited only by the appended claims.

What is claimed is:

1. A backscatter reduction device for reducing backscatter in x-ray imaging by attenuating backscattered x-rays, the backscatter reduction device comprising:
a first material for attenuating the backscattered x-rays; and
a second material for supporting the first material such that the backscatter reduction device forms a free-standing unit.

2. The backscatter reduction device of claim 1, wherein the first material is selected from the group consisting of lead, rubberized lead, foil lead, and lead equivalents.

3. The backscatter reduction device of claim 1, wherein the second material comprises plastic.

4. The backscatter reduction device of claim 1, wherein the second material is safe for contact with human skin.

5. The backscatter reduction device of claim 1, wherein the second material supports the first material on one side.

6. The backscatter reduction device of claim 1, wherein the second material supports the first material on two sides.

7. The backscatter reduction device of claim 1, wherein the first material is suspended in a matrix of the second material.

8. The backscatter reduction device of claim 1, further comprising a radiographic grid disposed relative to the first material such that in use, an x-ray imaging plate is disposed between the first material and the radiographic grid.

9. A method for reducing backscatter in x-ray imaging by attenuating backscattered x-rays, the method comprising:
(a) placing an x-ray source and an imaging plate relative to a region of interest to be imaged in order to image the region of image with x-rays from the x-ray source;
(b) placing a backscatter reduction device between the imaging plate and an object that backscatters the x-rays in order to attenuate the backscattered x-rays, the backscatter reduction device comprising a first material for attenuating the backscattered x-rays and a second material for supporting the first material such that the backscatter reduction device forms a free-standing unit; and
(c) imaging the region of interest using the x-ray source and the imaging plate while attenuating the backscattered x-rays with the backscatter reduction device.

10. The method of claim 9, wherein the first material is selected from the group consisting of lead, rubberized lead, foil lead, and lead equivalents.

11. The method of claim 9, wherein the second material comprises plastic.

12. The method of claim 9, wherein the second material is safe for contact with human skin.

13. The method of claim 9, wherein the second material supports the first material on one side.

14. The method of claim 9, wherein the second material supports the first material on two sides.

15. The method of claim 9, wherein the first material is suspended in a matrix of the second material.

16. The method of claim 9, wherein the x-ray source is a portable x-ray source.

17. The method of claim 9, further comprising placing a radiographic grid between the x-ray source and the imaging plate.
